(19) United States
(12) Patent Application Publication
(10) Pub. No.: US 2018/0348370 A1
(43) Pub. Date: Dec. 6, 2018

(54) DISTANCE INFORMATION ACQUISITION APPARATUS AND DISTANCE INFORMATION ACQUISITION METHOD

(71) Applicant: FUJIFILM Corporation, Tokyo (JP)

(72) Inventor: Tomoyuki KAWAI, Saitama-shi (JP)

(73) Assignee: FUJIFILM Corporation, Tokyo (JP)

(21) Appl. No.: 16/059,684

(22) Filed: Aug. 9, 2018

Related U.S. Application Data
(63) Continuation of application No. PCT/JP2017/001114, filed on Jan. 13, 2017.

(30) Foreign Application Priority Data
Feb. 23, 2016 (JP) 2016-031829

(51) Int. Cl. G01S 17/08; G01S 7/486; G01S 7/28

(52) U.S. Cl. CPC G01S 17/08; G01S 7/2813; G01S 7/4865

(57) ABSTRACT

The distance information acquisition apparatus includes: a measurement light source that emits measurement light to a measurement object; a distance image sensor in which a plurality of light receiving elements are two-dimensionally arranged; a jetting section that jets a reflection suppressing agent to the measurement object; an imaging lens that images the measurement light reflected on a surface of the measurement object to which the reflection suppressing agent jetted from the jetting section is attached on the distance image sensor; and a distance information acquisition section that acquires distance information of the surface of the measurement object, which is first distance information corresponding to a time of flight of the measurement light reflected from the reflection suppressing agent on the surface of the measurement object, on the basis of an output signal of each light receiving element of the distance image sensor.

### CROSS-REFERENCE TO RELATED APPLICATIONS

The present application is a Continuation of PCT International Application No. PCT/JP2017/001114 filed on Jan. 13, 2017 claiming priority under 35 U.S.C § 119(a) to Japanese Patent Application No. 2016-031829 filed on Feb. 23, 2016. Each of the above applications is hereby expressly incorporated by reference, in their entirety, into the present application.

### BACKGROUND OF THE INVENTION

### 1. Field of the Invention

The present invention relates to a distance information acquisition apparatus and a distance information acquisition method, and particularly, a technique for acquiring a distance based on a time of flight (TOF) method.

### 2. Description of the Related Art

A TOF method is a method for irradiating a subject with light and measuring a time until reflected light is received using a distance sensor to calculate a distance to the subject. As the TOF method, a method for irradiating a subject with pulse light and receiving reflected light using a distance sensor having a plurality of pixels to acquire distance information of the subject from the amount of received light (the intensity of received light) for each pixel of the distance sensor (hereinafter, referred to as a “pulse light detection method”), and a method for irradiating a subject with light that is modulated at high frequency and detecting a phase shift until reflected light is received from a point of time of irradiation (arrival time of reflected light) to acquire distance information are known.

In the related art, as a technique that performs distance measurement using the TOF method, a technique for enhancement of measurement accuracy has been proposed.

For example, a distance image acquisition apparatus disclosed in JP2008-145386A includes a distance image sensor in which a first pixel group having a first band pass filter that mainly targets infrared light of a wavelength λ₁ and a second pixel group having a second band pass filter that mainly targets infrared light of a wavelength λ₂ and has a light transmitting band that does not overlap that of the first band pass filter are arranged with a predetermined arrangement, and a light emitting section that emits pulse light of the infrared light of the wavelength λ₂, in which the pulse light of the infrared light of the wavelength λ₂ is emitted from the light emitting section, output data is respectively acquired from the first pixel group and the second pixel group of the distance image sensor, and the output data of the first pixel group is subtracted from the output data of the second pixel group, so that output data obtained by removing the influence of ambient light is acquired.

### SUMMARY OF THE INVENTION

Here, in the pulse light detection method based on the TOF method, information relating to a distance (hereinafter, referred to as distance information) is acquired on the basis of the intensity of received light in a case where a subject is irradiated with pulse light and reflected light is received by a distance sensor. Accordingly, in a case where the reflected light from the subject does not directly return to the distance sensor, the distance information does not represent an accurate value. That is, in a case where the reflected light from the subject is multiply reflected and is then received by the distance sensor, the influence of distance information about an optical path on which the reflected light is multiply reflected occurs, and thus, it may not be possible to obtain accurate distance information. Particularly, in a case where distance measurement is performed using the pulse light detection method based on the TOF method in a narrowly closed space such as the inside of a pipe, there is a high possibility that measurement light may be multiply reflected, which causes difficulties in acquisition of accurate distance information.

However, JP2008-145386A does not mention a method for reducing multiple reflection of measurement light to acquire accurate distance information.

The invention has been made in consideration of the above-mentioned circumstances, and an object of the invention is to provide a distance information acquisition apparatus and a distance information acquisition method capable of reducing the influence due to multiple reflection of measurement light to acquire accurate distance information.

In order to achieve the above object, according to an aspect of the invention, there is provided a distance information acquisition apparatus comprising: a measurement light source that emits measurement light to a measurement object; a distance image sensor in which a plurality of light receiving elements are two-dimensionally arranged; a jetting section that jets a reflection suppressing agent to the measurement object; an imaging lens that images the measurement light reflected on a surface of the measurement object to which the reflection suppressing agent jetted from the jetting section is attached on the distance image sensor; and a distance information acquisition section that acquires distance information of the surface of the measurement object, which is first distance information corresponding to a time of flight of the measurement light reflected from the reflection suppressing agent on the surface of the measurement object, on the basis of an output signal of each light receiving element of the distance image sensor.

According to this aspect of the invention, the reflection suppressing agent is jetted onto the measurement object, and the distance information corresponding to the time of flight of the measurement light reflected from the reflection suppressing agent attached to the surface of the measurement object is acquired. Thus, according to this aspect, it is possible to suppress reflection of the measurement light using the reflection suppressing agent attached to the surface of the measurement object and to diffuse-reflect the measurement light, and thus, it is possible to acquire accurate distance information.

Preferably, the distance information acquisition section acquires second distance information corresponding to a time of flight of the measurement light reflected on the surface of the measurement object to which the reflection suppressing agent is not attached, the distance information acquisition apparatus further comprises a multiple reflection determination section that determines that the measurement light is multiply reflected on the basis of the second distance information, and in a case where the multiple reflection determination section determines that the measurement light is multiply reflected, the jetting section jets the reflection suppressing agent, and in a case where the multiple reflection determination section determines that the measurement light is not multiply reflected, the jetting section does not jet the reflection suppressing agent.

According to this aspect of the invention, the distance information corresponding to the time of flight of the measurement light reflected on the surface of the measurement object to which the reflection suppressing agent is not attached is acquired, and it is determined whether the measurement light reflected on the surface of the measurement object is multiply reflected. Further, in a case where it is determined that the measurement light is multiply reflected, the jetting section jets the reflection suppressing agent, and in a case where it is determined that the measurement light is not multiply reflected, the jetting section does not jet the reflection suppressing agent. Thus, according to this aspect of the invention, in a case where there is an influence of the multiple reflection of the measurement light in the acquired distance information, it is possible to acquire accurate distance information in which the influence of the multiple reflection of the measurement light is suppressed by jetting the reflection suppressing agent, and in a case where there is no influence of the multiple reflection of the measurement light, it is possible to efficiently acquire accurate distance information without jetting the reflection suppressing agent.

Preferably, in a case where the second distance information continuously changes from a short distance to a long distance, the multiple reflection determination section determines that the measurement light is not multiply reflected, and in a case where the second distance information non-continuously changes from the short distance to the long distance, the multiple reflection determination section determines that the measurement light is multiply reflected.

According to this aspect of the invention, in a case where the acquired distance information continuously changes from the short distance to the long distance, the multiple reflection determination section determines that the measurement light is not multiply reflected, and in a case where the second distance information non-continuously changes from the short distance to the long distance, the multiple reflection determination section determines that the measurement light is multiply reflected. Thus, according to this aspect of the invention, it is possible to accurately determine whether the measurement light is multiply reflected, and thus, it is possible to perform jetting of the reflection suppressing agent in an appropriate case to thereby efficiently acquire accurate distance information. Particularly, in a case where there is a portion for which distance information is non-continuous on an entire surface of the distance image sensor in which light receiving elements are two-dimensionally arranged, in many cases, there is an influence of the multiple reflection of the measurement light. According to this aspect of the invention, it is possible to determine the multiple reflection of the measurement light with high accuracy.

Preferably, in a case where the second distance information repeats binary values in a region, the multiple reflection determination section determines that the measurement light is multiply reflected, and in a case where the second distance information does not repeat the binary values in the region, the multiple reflection determination section determines that the measurement light is not multiply reflected.

According to this aspect of the invention, in a case where the distance information repeats binary values in a region, the multiple reflection determination section determines that the measurement light is multiply reflected, and in a case where the distance information does not repeat binary values in a region, the multiple reflection determination section determines that the measurement light is not multiply reflected. Thus, according to this aspect of the invention, it is possible to more accurately determine whether the measurement light is multiply reflected, and thus, it is possible to perform jetting of the reflection suppressing agent in an appropriate case to thereby efficiently acquire accurate distance information. Particularly, in a case where a localized region is focused, and in a case where distance information repeats two values, in many cases, there is an influence of the multiple reflection of the measurement light. According to this aspect of the invention, it is possible to determine the multiple reflection of the measurement light with high accuracy.

Preferably, the reflection suppressing agent reflects the measurement light with a uniform reflectivity.

According to this aspect of the invention, since the reflection suppressing agent reflects the measurement light with the uniform reflectivity, it is possible to accurately acquire the distance information in the distance information acquisition section. Particularly, in a case where the light intensity of the measurement light received by the distance image sensor is converted into a time of flight of the measurement light to acquire distance information, it is possible to acquire accurate distance information by reflecting the measurement light with the uniform reflectivity.

Preferably, the reflection suppressing agent includes fine particles.

According to this aspect of the invention, since the reflection suppressing agent includes fine particles and is thus attached regardless of the shape of a measurement object, it is possible to suppress multiple reflection of the measurement light to diffuse-reflect the measurement light.

Preferably, the diameters of the fine particles are 1/10 or greater and 10 times or smaller of a wavelength of the measurement light.

According to this aspect of the invention, since the diameters of the fine particles that are the reflection suppressing agent are 1/10 or greater and 10 times or smaller of the wavelength of the measurement light, it is possible to effectively diffuse-reflect the measurement light.

Preferably, the distance information acquisition apparatus further comprises: a discharge section that discharges the reflection suppressing agent that is not attached to the surface of the measurement object in the reflection suppressing agent jetted by the jetting section, in which the distance information acquisition section acquires the distance information after the discharge in the discharge section is terminated.

According to this aspect of the invention, the reflection suppressing agent that is not attached to the surface of the measurement object in the reflection suppressing agent jetted by the jetting section is discharged, and the distance information acquisition section acquires the distance information after the discharge in the discharge section is terminated. Thus, according to this aspect of the invention, it is possible to suppress the influence of the reflection suppressing agent that is not attached and floats in the measurement space on the measurement light, and thus, it is possible to acquire accurate distance information. The reflection suppressing agent that is not attached to the surface of the measurement object discharged by the discharge section also includes a reflection suppressing agent that is attached to the surface of the measurement object but is separated clue to the discharge in the discharge section.

Preferably, the discharge section discharges the reflection suppressing agent by performing suction or extrusion.

According to this aspect of the invention, since the discharge section discharges the reflection suppressing agent by performing suction or extrusion, particularly, in a case where the measurement object is in a closed space such as a tunnel, a tube, or a pipe, it is possible to efficiently discharge the reflection suppressing agent.

Preferably, the distance information acquisition apparatus further comprises: a first attachment prevention section that prevents the reflection suppressing agent from being attached to the imaging lens.

According to this aspect of the invention, since the attachment prevention section that prevents the reflection suppressing agent from being attached to the imaging lens is provided, it is possible to prevent the reflection suppressing agent from being attached to the imaging lens, and to suppress the influence of the reflection suppressing agent on the measurement light received by the imaging lens.

Preferably, the first attachment prevention section is formed by a wiper.

Preferably, the first attachment prevention section is formed by a cover that covers the imaging lens.

Preferably, the cover covers the imaging lens from a time before the jetting section jets the reflection suppressing agent to a time after the discharge section finishes discharging the reflection suppressing agent.

According to this aspect of the invention, the cover covers the imaging lens from the time before the jetting section jets the reflection suppressing agent to the time after the discharge section finishes discharging the reflection suppressing agent. Thus, according to this aspect of the invention, while the jetting section is jetting the reflection suppressing agent, the cover covers the imaging lens to prevent attachment of the reflection suppressing agent, and in a case where the imaging lens images the measurement light, the measurement light is not affected by the influence of the cover, and thus, it is possible to acquire accurate distance information.

Preferably, the distance information acquisition apparatus further comprises: a first attachment prevention section that prevents the reflection suppressing agent from being attached to the imaging lens, the first attachment prevention section is a cover, and the cover covers the imaging lens while the jetting section is jetting the reflection suppressing agent.

According to this aspect of the invention, the cover that prevents the reflection suppressing agent from being attached to the imaging lens covers the imaging lens the jetting section is jetting the reflection suppressing agent. Thus, according to this aspect of the invention, while the jetting section is jetting the reflection suppressing agent, the cover covers the imaging lens to prevent attachment of the reflection suppressing agent, and in a case where the imaging lens images the measurement light, interference with a traveling path of the measurement light is suppressed.

Preferably, the distance information acquisition apparatus further comprises: a second attachment prevention section that prevents the reflection suppressing agent from being attached to the measurement light source.

According to this aspect of the invention, since it is possible to prevent the reflection suppressing agent from being attached to the measurement light source by the second attachment prevention section, it is possible to suppress the influence on the measurement light due to attachment of the reflection suppressing agent to the measurement light source.

Preferably, the second attachment prevention section is a wiper.

Preferably, the second attachment prevention section is a cover that covers the measurement light source.

Preferably, the cover covers the measurement light source from a time before the jetting section jets the reflection suppressing agent to a time after the discharge section finishes discharging the reflection suppressing agent.

According to this aspect of the invention, the cover covers the measurement light source from the time before the jetting section jets the reflection suppressing agent to the time after the discharge section finishes discharging the reflection suppressing agent. Thus, according to this aspect of the invention, while the jetting section is jetting the reflection suppressing agent, the cover covers the measurement light source to prevent attachment of the reflection suppressing agent, and in a case where the measurement light source emits the measurement light, the measurement light is not affected by the influence of the cover, and thus, it is possible to acquire accurate distance information.

Preferably, the distance information acquisition apparatus further comprises: a second attachment prevention section that prevents the reflection suppressing agent from being attached to the measurement light source, in which the second attachment prevention section is a cover, and the cover covers the measurement light source while the jetting section is jetting the reflection suppressing agent.

According to this aspect of the invention, the cover covers the measurement light source while the jetting section is jetting the reflection suppressing agent. Thus, according to this aspect of the invention, in a case where the jetting section jets the reflection suppressing agent, the cover covers the measurement light source to prevent attachment of the reflection suppressing agent, and in a case where the measurement light source emits the measurement light, the measurement light is not affected by the influence of the cover, and thus, it is possible to acquire accurate distance information.

According to another aspect of the invention, there is provided a distance information acquisition method comprising: a step of emitting measurement light to a measurement object; a step of jetting a reflection suppressing agent to the measurement object; a step of imaging the measurement light reflected on a surface of the measurement object to which the reflection suppressing agent jetted in the jetting step is attached on a distance image sensor in which a plurality of light receiving elements are two-dimensionally arranged, using an imaging lens; and a step of acquiring distance information of the surface of the measurement object, which is first distance information corresponding to a time of flight of the measurement light reflected from the reflection suppressing agent on the surface of the measurement object, on the basis of an output signal of each light receiving element of the distance image sensor.

According to the invention, since a reflection suppressing agent is jetted onto a measurement object and distance information corresponding to a time of flight of the measurement light reflected from the reflection suppressing agent attached to a surface of the measurement object is acquired, it is possible to suppress reflection of the measurement light and to diffuse-reflect the measurement light using the reflection suppressing agent attached to the surface of the measurement object to thereby acquire accurate distance information.

### BRIEF DESCRIPTION OF THE DRAWINGS

FIG. 1 is a block diagram showing a functional configuration example of a distance information acquisition apparatus.

FIG. 2 is a conceptual diagram showing a case where measurement light is mirror-reflected on a surface of a measurement object.

FIG. 3 is a conceptual diagram showing a case where measurement light is multiply reflected in a measurement object.

FIG. 4 is a conceptual diagram showing a case where measurement light is diffuse-reflected on a surface to which a reflection suppressing agent is attached.

FIG. 5 is a flowchart showing an operation of the distance information acquisition apparatus.

FIG. 6 is a block diagram showing a functional configuration example of the distance information acquisition apparatus.

FIG. 7 is a histogram generated on the basis of distance information.

FIG. 8 is a flowchart showing an operation of the distance information acquisition apparatus.

FIG. 9 is a block diagram showing a functional configuration example of the distance information acquisition apparatus.

FIG. 10 is a flowchart showing an operation of the distance information acquisition apparatus.

FIG. 11 is a block diagram showing a functional configuration example of the distance information acquisition apparatus.

FIG. 12 is a block diagram showing a functional configuration example of the distance information acquisition apparatus.

FIG. 13 is a flowchart showing an operation of the distance information acquisition apparatus.

FIG. 14 is a block diagram showing a functional configuration example of the distance information acquisition apparatus.

### DESCRIPTION OF THE PREFERRED EMBODIMENTS

Embodiments of a distance information acquisition apparatus and a distance information acquisition method according to the invention will be described with reference to the accompanying drawings.

### First Embodiment

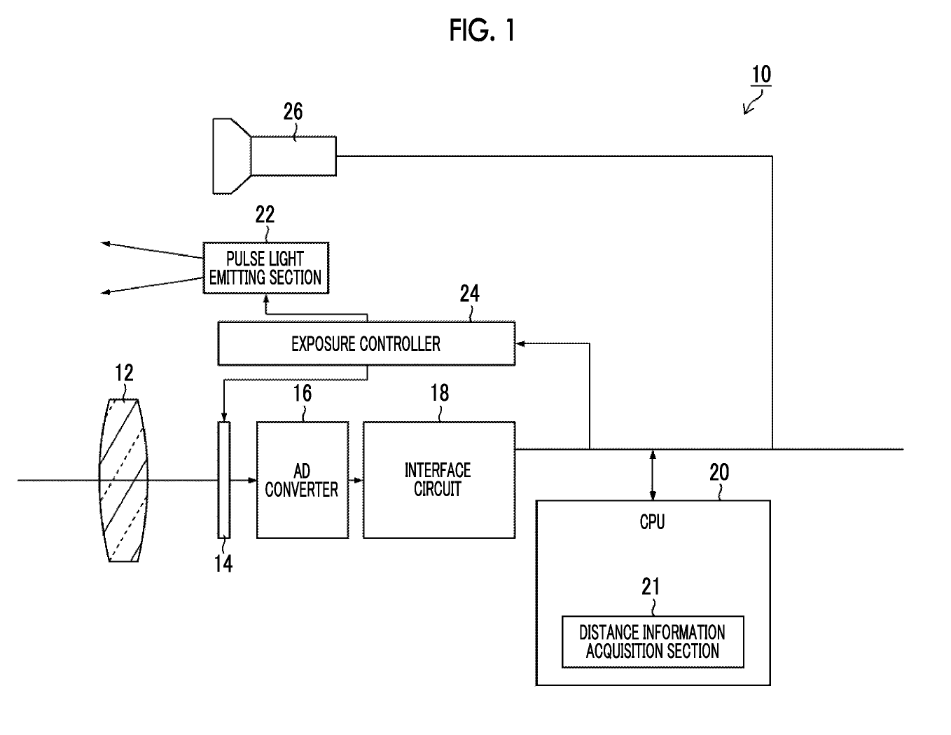

FIG. 1 is a block diagram showing a functional configuration example of a distance information acquisition apparatus 10 according to a first embodiment of the invention.

A distance information acquisition apparatus 10 shown in FIG. 1 is a distance information acquisition apparatus of a pulse light detection method, and includes an imaging lens 12, a distance image sensor 14, an analog-to-digital (AD) converter 16, an interface circuit 18, a central processing unit (CPU) 20, a pulse light emitting section 22, an exposure controller 24, a distance information acquisition section 21, and a jet 26 as main components.

The pulse light emitting section 22 is a measurement light source that emits measurement light to a measurement object, which includes a near infrared light emitting diode (near infrared light emitting diode (LED)) and emits pulse light of a predetermined pulse width in synchronization with a light emission timing signal from the exposure controller 24. The pulse light emitted from the near infrared LED of the pulse light emitting section 22 is near infrared light. Further, the measurement object of the distance information acquisition apparatus 10 and the distance information acquisition method of the invention is not particularly limited. For example, the measurement object is an industrial product such as a pipe, a tube, a tunnel, an airplane, or a vehicle, and a structure such as a power station. Further, the distance information acquisition apparatus 10 may be provided in an endoscope to be used when observing the inside of the body.

The imaging lens 12 images reflected light from the measurement object on the distance image sensor 14. The imaging lens 12 images measurement light reflected on a surface of the measurement object and measurement light reflected on a surface of the measurement object to which a reflection suppressing agent is attached on the distance image sensor 14. Here, the measurement light refers to light emitted from the pulse light emitting section 22, light reflected on the surface of the measurement object, and light reflected on the surface of the measurement object to which the reflection suppressing agent is attached.

The distance image sensor 14 is configured of a complementary metal-oxide semiconductor (CMOS) driver having a vertical driver, a horizontal driver, and the like, and a CMOS type image sensor driven by a timing generator. The distance image sensor 14 is not limited to the CMOS type, and may be an XY array type image sensor or a charge coupled device (CCD) type image sensor.

In the distance image sensor 14, a plurality of light receiving elements (photodiodes) are two-dimensionally arranged. Here, on an incident surface side of the plurality of light receiving, elements, a band pass filter that transmits only a wavelength band of near infrared pulse light emitted from the pulse light emitting section 22 or a visible light cut filter that removes visible light is provided. Thus, the plurality of light receiving elements of the distance image sensor 14 function as pixels having sensitivities with respect to near infrared light. In a case where the distance image sensor 14 employs the distance image sensor 14 in which the plurality of light receiving elements are two-dimensionally arranged, since measurement light is received over an overall region of the distance image sensor 14 through the imaging lens 12, the influence of multiple reflection of the measurement light is easily shown. Accordingly, in a case where the distance image sensor 14 has a configuration in which the plurality of light receiving elements are two-dimensionally arranged, it is possible to acquire distance information by suppressing multiple reflection as described in the invention to thereby acquire accurate distance information. As the distance image sensor 14, a line sensor in which a plurality of light receiving elements are one-dimensionally arranged may be used. Further, instead of the pulse light emitting section 22, a method of scanning laser spot light and receiving measurement light using the distance image sensor 14 may be used to suppress multiple reflection of measurement light, but in this method, a time for scanning the laser spot light is necessary.

In the distance image sensor 14, an exposure period (exposure time and exposure timing) is controlled by a shutter control signal applied from the exposure controller 24, and electric charges corresponding to the intensity of incident near infrared light during the exposure period are accumulated in each light receiving element of the distance image sensor 14. Further, a pixel signal based on the intensity of incident near infrared light from the measurement object (an analog signal corresponding to the electric charges accumulated in each pixel) is read out from the distance image sensor 14. Here, the exposure controller 24 controls light emission of pulse light in the pulse light emitting section 22.

The analog signal read out from the distance image sensor 14 after the exposure control in the exposure controller 24 is converted into a digital signal by the AD converter 16, and is provided to the CPU 20 through the interface circuit 18 that functions as an image input controller. The CMOS type image sensor may include an AD converter. In this case, the AD converter 16 may not be provided.

The jet (jetting section) 26 jets a reflection suppressing agent to a measurement object. A timing when the jet 26 jets the reflection suppressing agent is set according to a command from the CPU 20, and the command for the jetting timing of the jet 26 may be performed by signal transmission through a manual input of a user, or may be performed by automatic signal transmission at a predetermined timing. The jet 26 is not particularly limited as long as it is a jet having a function capable of jetting a reflection suppressing agent, and a known jetting device may be used. The jet 26 is filled with a predetermined reflection suppressing agent, which is not shown in the figure.

The reflection suppressing agent has a function for suppressing reflection on a surface of a measurement object, and for example, is able to suppress total reflection such as metallic reflection. Further, the reflection suppressing agent has a function for being attached to the surface of the measurement object. Further, it is preferable that the reflection suppressing agent has a function for being separated from the surface of the measurement object after acquisition of distance information. The shape of the reflection suppressing agent may be fine particles or liquid. For example, the reflection suppressing agent is metallic fine particles, resin fine particles, or colored water (including a liquid state or a mist state). In a case where the reflection suppressing agent is fine particles, it is preferable that their diameters are 1/10 or greater and 10 times or smaller of a wavelength of measurement light. In a case where the diameters of the fine particles are 1/10 or greater and 10 times or smaller of the wavelength of the measurement light, it is possible to effectively suppress multiple reflection of the measurement light. Further, it is preferable that the reflection suppressing agent reflects the measurement light with a uniform reflectivity.

The CPU 20 has functions of acquisition of distance information (distance information acquisition section 21), output of an exposure control command to the exposure controller 24, and control of the jet 26.

The distance information acquisition section 21 acquires a sensor output from the distance image sensor 14 through the interface circuit 18 according to an exposure control of the exposure controller 24. Further, the distance information acquisition section 21 calculates a distance of a measurement object in association with electric charges accumulated for each light receiving element of the distance image sensor 14, and calculates the distance of the measurement object corresponding to all the light receiving elements to thereby generate distance information (for example, a distance image) of the measurement object in a distance measurement region. Here, the distance information refers to information relating to the distance calculated in accordance with the electric charges accumulated for each light receiving element, and includes distance information (second distance information) calculated on the basis of measurement light reflected on a surface of the measurement object and distance information (first distance information) calculated on the basis of measurement light reflected from the reflection suppressing agent attached to the surface of the measurement object. Further, the distance image refers to an image that shows a distribution of pieces of information relating to distances in association with the two-dimensional distance image sensor 14.

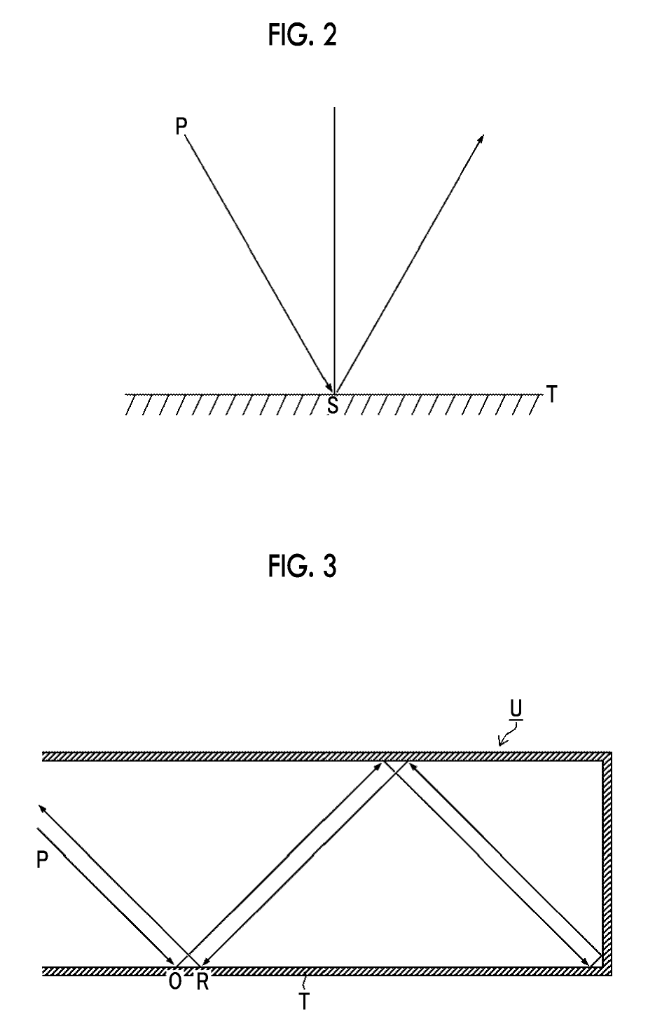

FIGS. 2 and 3 are diagrams illustrating an influence due to multiple reflection of measurement light in distance information acquired by the distance information acquisition apparatus 10.

FIG. 2 is a conceptual diagram showing a case where measurement light P is mirror-reflected on a surface T of a measurement object, and FIG. 3 is a conceptual diagram showing a case where measurement light P is multiply reflected in a measurement object.

As shown in FIG. 2, in a case where the measurement object is made of metal, and the measurement light P is subjected to total reflection such as metallic reflection on the surface T of the measurement object, the multiply reflected measurement light P maintains a high light intensity, and is then received in the distance image sensor 14.

As shown in FIG. 3, in a pipe U having the surface T that is a mirror surface as shown in FIG. 2, the measurement light P is multiply reflected. In this way, in a case where distance information is acquired by the distance information acquisition section 21 on the basis of the multiply reflected measurement light P, since a path of the measurement light P is changed due to multiple reflection, it is not possible to acquire accurate distance information. That is, although a distance between a point O in the figure and a point R in the figure is originally continuously changed from the shape of the pipe U, in a case where the measurement light P is multiply reflected, distance information of the point O and distance information of the point R show non-continuous values.

Further, returning to FIG. 2, in a case where the surface T of the measurement object is a mirror surface, the measurement light P is reflected on the surface T, but there is a case where the measurement light P does not directly return toward the imaging lens 12 for mirror reflection (specular reflection) and travels in a different direction. That is, although the measurement light P is reflected at a point S of the surface T, since the surface T is a mirror surface, the measurement light P may not directly return toward the imaging lens 12 and may travel in a different direction.

In the invention, it is possible to acquire accurate distance information by suppressing the influence of the multiple reflection and the influence of the mirror reflection of the measurement light P described in FIGS. 2 and 3.

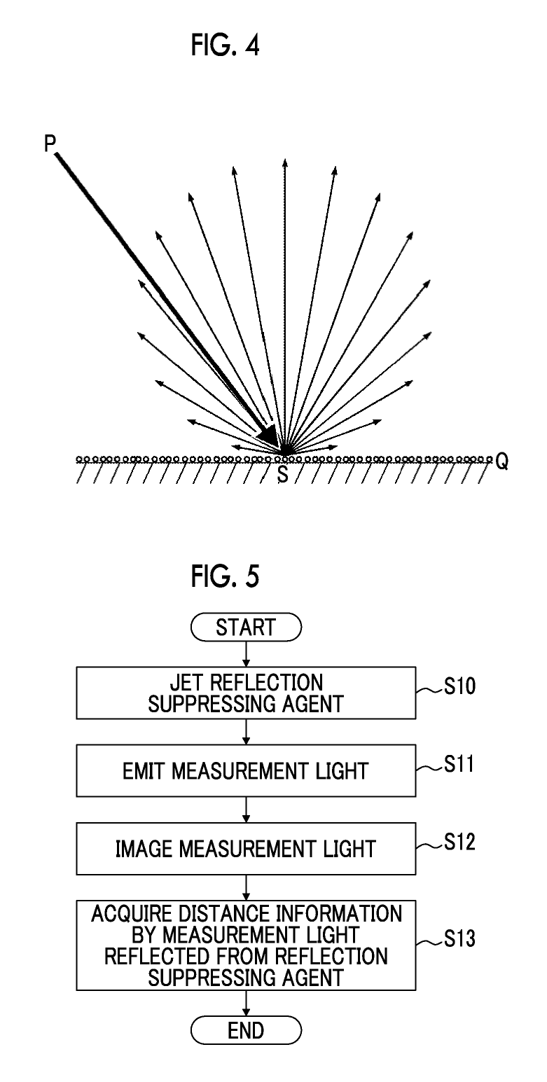

FIG. 4 is a conceptual diagram showing a case where measurement light P is diffuse-reflected on a surface Q to which a reflection suppressing agent is attached. As shown in FIG. 4, on the surface Q to which the reflection suppressing agent is attached, the measurement light P is diffuse-reflected. As the measurement light P is diffuse-reflected, the light intensity of the diffuse-reflected measurement light P becomes weak. Even in a case where the measurement light P is multiply reflected, the influence on distance information is suppressed. That is, in a case where the measurement light P is multiply reflected on the surface to which the reflection suppressing agent is attached, since the light intensity becomes very weak, the multiply reflected measurement light that is received by the distance image sensor 14 also becomes weak, and thus, the influence on distance information is suppressed. Further, there is reflected light that is directly incident onto the imaging lens 12 from the point S in the measurement light P that is diffuse-reflected, and thus, it is possible to acquire distance information by the directly incident measurement light P.

FIG. 5 is a flowchart showing an operation of the distance information acquisition apparatus 10 of this embodiment.

First, a reflection suppressing agent is jetted onto a surface of a measurement object by the jet 26 (step S10). The reflection suppressing agent jetted by the jet 26 is attached to the surface of the measurement object. Then, measurement light P is emitted by the pulse light emitting section 22 (step S11). Then, the measurement light P reflected on the surface of the measurement object to which the jetted reflection suppressing agent is attached is imaged in the distance image sensor 14 through the imaging lens 12 (step S12). Then, distance information corresponding to a time of flight of the measurement light P reflected from the reflection suppressing agent on the surface of the measurement object, which is distance information of the surface of the measurement object, on the basis of an output signal of each light receiving element of the distance image sensor 14, is acquired by the distance information acquisition section 21 (step S13).

The above-described configurations and functions may be appropriately realized by predetermined hardware, software, or a combination thereof. For example, the invention may be applied to a program for causing a computer to execute the above-described processing steps (processing procedure), a computer readable recording medium on which such a program is recorded (non-temporary recording medium), or a computer in which such a program can be installed.

### Second Embodiment

Next, a second embodiment of the invention will be described. In this embodiment, a multiple reflection determination section 25 that determines whether or not measurement light P is multiply reflected is provided, and a reflection suppressing agent is jetted from the jet 26 on the basis of the determination result. Further, in this embodiment, a discharger 28 that discharges the reflection suppressing agent from a measurement space is provided.

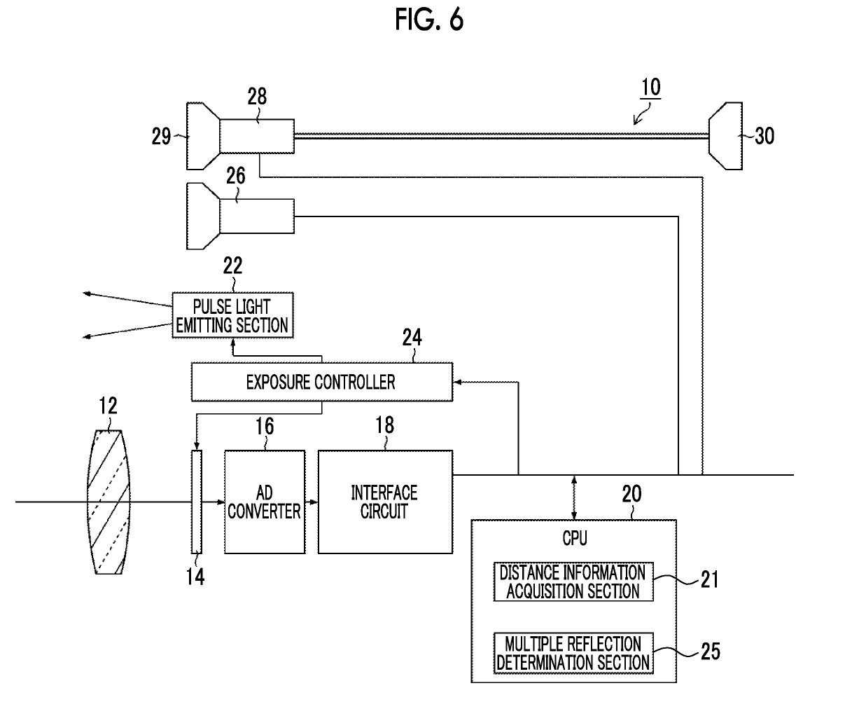

FIG. 6 is a block diagram showing a functional configuration example of a distance information acquisition apparatus 10 according to the invention. The same reference numerals are given to the same portions described in FIG. 1, and description thereof will not be repeated.

The distance information acquisition apparatus 10 shown in FIG. 6 includes the multiple reflection determination section 25 in a CPU 20.

The multiple reflection determination section 25 acquires distance information corresponding to a time of flight of measurement light P reflected on a surface of a measurement object to which a reflection suppressing agent is not attached, and determines whether the measurement light P is multiply reflected on the basis of the acquired distance information.

As a method for determining whether the measurement light P is multiply reflected by the multiple reflection determination section 25, various known methods may be employed. For example, the multiple reflection determination section 25 may determine whether the measurement light P is multiply reflected on the basis of distance information for each pixel and a histogram of the number of pixels.

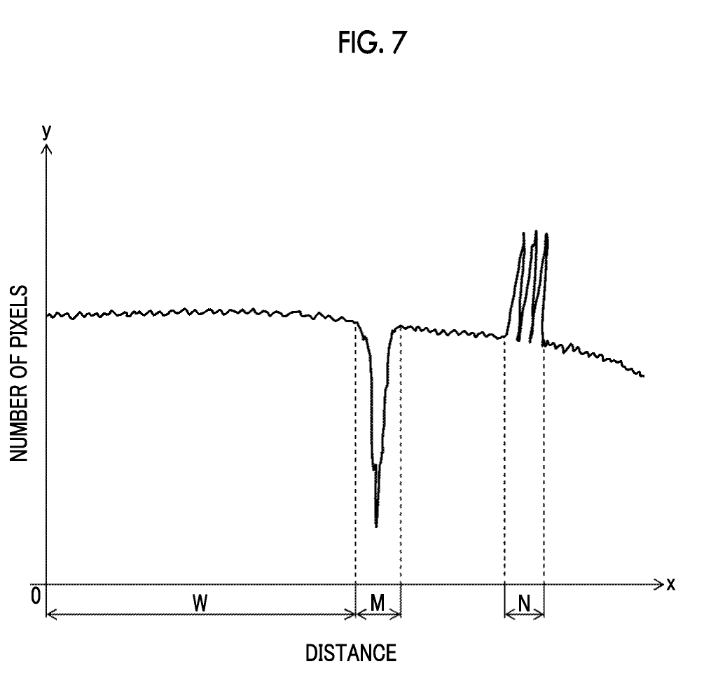

FIG. 7 is a histogram generated on the basis of distance information acquired from the distance information acquisition section 21 in the CPU 20. In FIG. 7, an x-axis represents distance information (distance) of each pixel, and a y-axis represents the number of pixels.

In a case where distance information is not affected by multiple reflection of the measurement light P, the number of pixels indicating distance information from a short distance to a long distance continuously changes although it also varies according to measurement objects. For example, in a case where the distance information in FIG. 7 is in a range of W, the number of pixels indicating the distance information continuously changes.

On the other hand, in a case where the measurement light P is multiply reflected, there is a case where a non-continuous change occurs in the number of pixels indicating distance information. For example, in a case where the distance information is in a range of M in FIG. 7, the number of pixels non-continuously decreases. In a case where the number of pixels indicating distance information at a certain distance rapidly decreases, or in a case where the number of pixels indicating distance information at a certain distance rapidly increases, there is a high possibility that the distance information is affected by multiple reflection of the measurement light P. Accordingly, in a case where distance information (second distance information) continuously changes from a short distance to a long distance, the multiple reflection determination section 25 determines that the measurement light P is not multiply reflected, and in a case where the distance information (second distance information) non-continuously changes from a short distance to a long distance, the multiple reflection determination section 25 determines that the measurement light P is multiply reflected. Here, for example, the non-continuous change may be defined as a non-continuous change in a case where a value of a difference (absolute value) between adjacent distances shows a change of a threshold value or greater.

Further, in a case where the measurement light P is multiply reflected, there is a case where binary values are repeated in a local range in the number of pixels indicating distance information. For example, in a case where the distance information is in a range of N in FIG. 7, binary values are repeated. In a case where the distance information non-continuously repeats binary values in a local range, there is a high possibility that the distance information is affected by multiple reflection of the measurement light P. Accordingly, in a case where the second distance information repeats binary values within a region, the multiple reflection determination section 25 determines that the measurement light P is multiply reflected, and in a case where the second distance information does not repeat binary values within the region, the multiple reflection determination section 25 determines that the measurement light P is not multiply reflected. Here, for example, the repeating of the binary values in the local area means a case where binary values between which a difference is equal to or greater than a threshold value are repeated in a range of 100 pixels, preferably, a range of 50 pixels.

Returning to FIG. 6, the discharger (discharge section) 28 discharges a reflection suppressing agent that is not attached to a surface of a measurement object in the reflection suppressing agent jetted by the jet 26. In a case where the discharger 28 performs discharging, after the discharge in the discharger 28 is terminated, distance information is acquired by the distance information acquisition section 21. Here, the discharger 28 discharges the reflection suppressing agent that is not attached to the surface of the measurement object, but the discharged reflection suppressing agent may include a reflection suppressing agent that is attached to the surface of the measurement object. The discharger 28 discharges the reflection suppressing agent by performing, suction or extrusion. The discharger 28 shown in FIG. 6 is configured of a suction port 29 and a discharge port 30, suctions the reflection suppressing agent through the suction port 29, and discharges the reflection suppressing agent through the discharge port 30. Control of the discharger 28 is performed by the CPU 20.

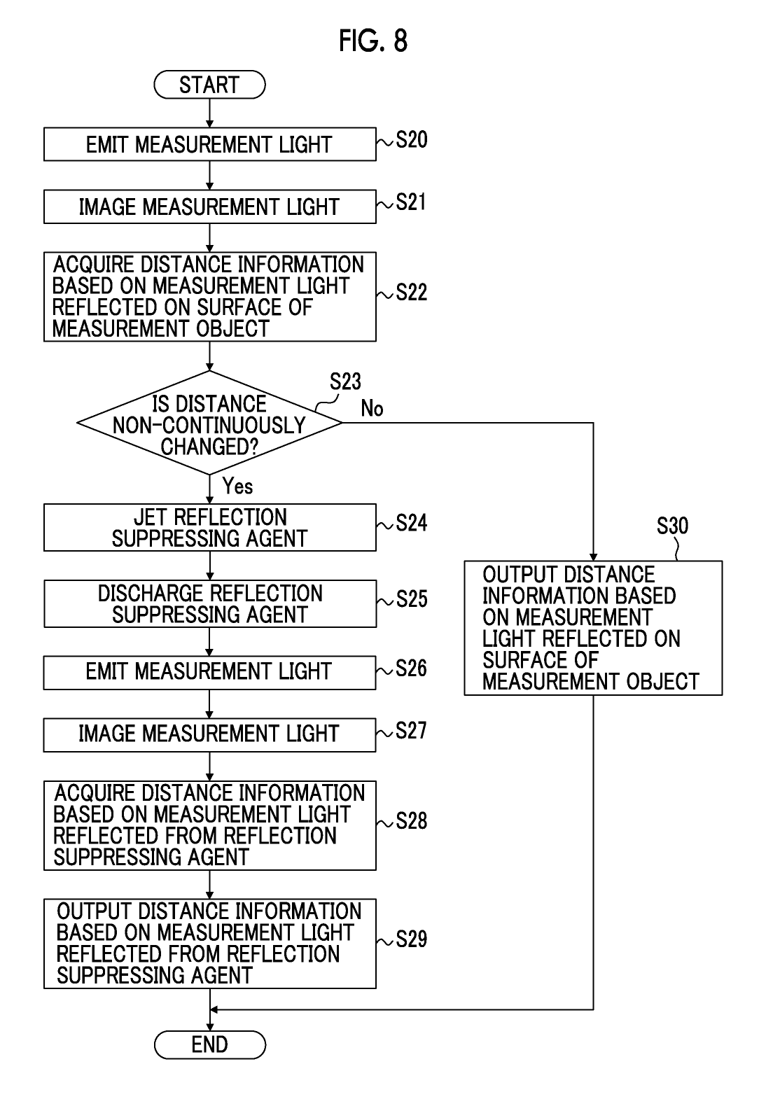

FIG. 8 is a flowchart showing an operation of the distance information acquisition apparatus 10 of this embodiment.

First, measurement light P is emitted to a measurement object by the pulse light emitting section 22 (step S20). In this case, jetting of a reflection suppressing agent is not performed with respect to the measurement object, and the measurement light P is reflected on a surface of the measurement object. Then, the measurement light P reflected on the surface of the measurement object is imaged on the distance image sensor 14 through the imaging lens 12 (step S21). Further, distance information based on the measurement light P reflected on the surface of the measurement object is acquired by the distance information acquisition section 21 (step S22). Then, on the basis of the acquired distance information, the multiple reflection determination section 25 determines whether the measurement light P is multiply reflected (step S23). For example, in a case where distance information continuously changes from a short distance to a long distance, the multiple reflection determination section 25 determines that the measurement light P is not multiply reflected (No in step S23). In this case, the distance information acquisition apparatus 10 outputs distance information based on the measurement light P reflected on the surface of the measurement object as a measurement result by the CPU 20 (step S30).

On the other hand, in a case where the distance information non-continuously changes from the short distance to the long distance, the multiple reflection determination section 25 determines that the measurement light P is multiply reflected (Yes in step S23). In this case, a command of jetting of the reflection suppressing agent is transmitted from the CPU 20, and the reflection suppressing agent is jetted onto the measurement object by the jet 26 (step S24). Then, the reflection suppressing agent is discharged from a measurement space by the discharger 28 (step S25). The discharge of the reflection suppressing agent in the discharger 28 may be terminated by discharging a predetermined amount of reflection suppressing agent (for example, 80% of the jetted reflection suppressing agent), or may be terminated at a set time.

After the discharge of the reflection suppressing agent is terminated, light emission of the measurement light P is performed by the pulse light emitting section 22 (step S26). The measurement light P emitted by the pulse light emitting section 22 is reflected from the reflection suppressing agent of the surface of the measurement object since the reflection suppressing agent is attached to the surface of the measurement object. That is, multiple reflection of the measurement light P reflected from the reflection suppressing agent of the surface of the measurement object is suppressed. Then, the measurement light P reflected from the reflection suppressing agent is imaged in the distance image sensor 14 through the imaging lens 12 (step S27). Then, the distance information acquisition section 21 acquires distance information based on the measurement light P reflected from the reflection suppressing agent (step S28). Further, the distance information acquisition apparatus 10 outputs the distance information based on the measurement light P reflected from the reflection suppressing agent by the CPU 20 (step S29).

### Third Embodiment

Next, a third embodiment of the invention will be described. In this embodiment, an attachment prevention section (first attachment prevention section) of the imaging lens 12 for preventing a reflection suppressing agent from being attached to the imaging lens 12 is provided.

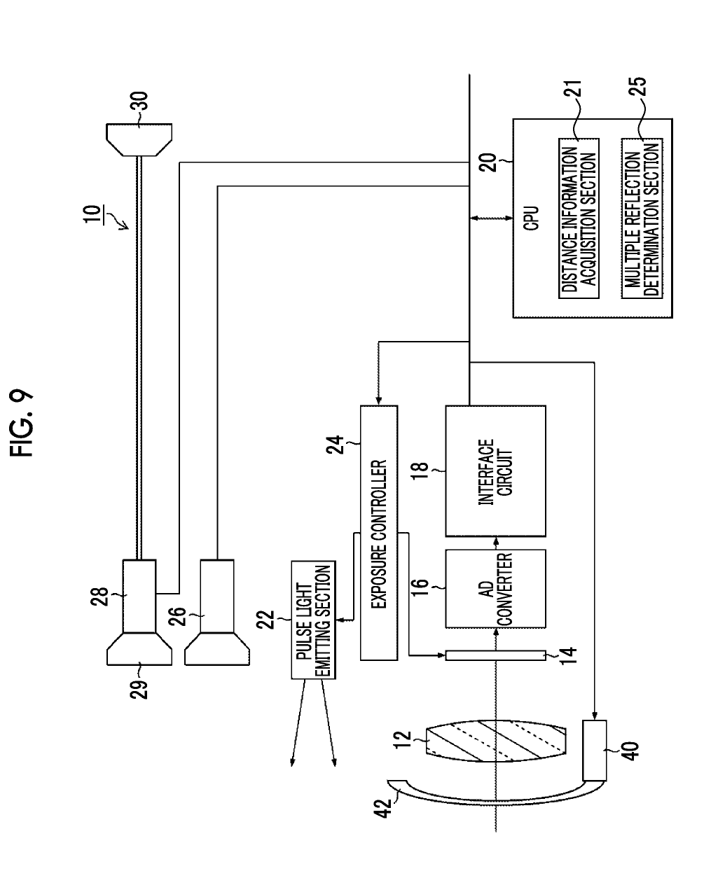

FIG. 9 is a block diagram showing a functional configuration example of the distance information acquisition apparatus 10 according to the third embodiment. The same reference numerals are given to the same portions described in FIGS. 1 and 6, and description thereof will not be repeated.

The distance information acquisition apparatus 10 shown in FIG. 9 includes a lens cover 42 for preventing attachment to the imaging lens 12, and the lens cover 42 is opened or closed by a cover operating mechanism 40. The lens cover 42 is a cover that covers the imaging lens 12, and prevents a reflection suppressing agent from being attached to the imaging lens 12.

For example, the lens cover 42 covers the imaging lens 12 from a time before the jet 26 jets the reflection suppressing agent to a time after the discharger 28 finishes discharging the reflection suppressing agent. Thus, it is possible to prevent the reflection suppressing agent from being attached to the imaging lens 12, and imaging of measurement light P performed by the imaging lens 12 is not affected due to the reflection suppressing agent.

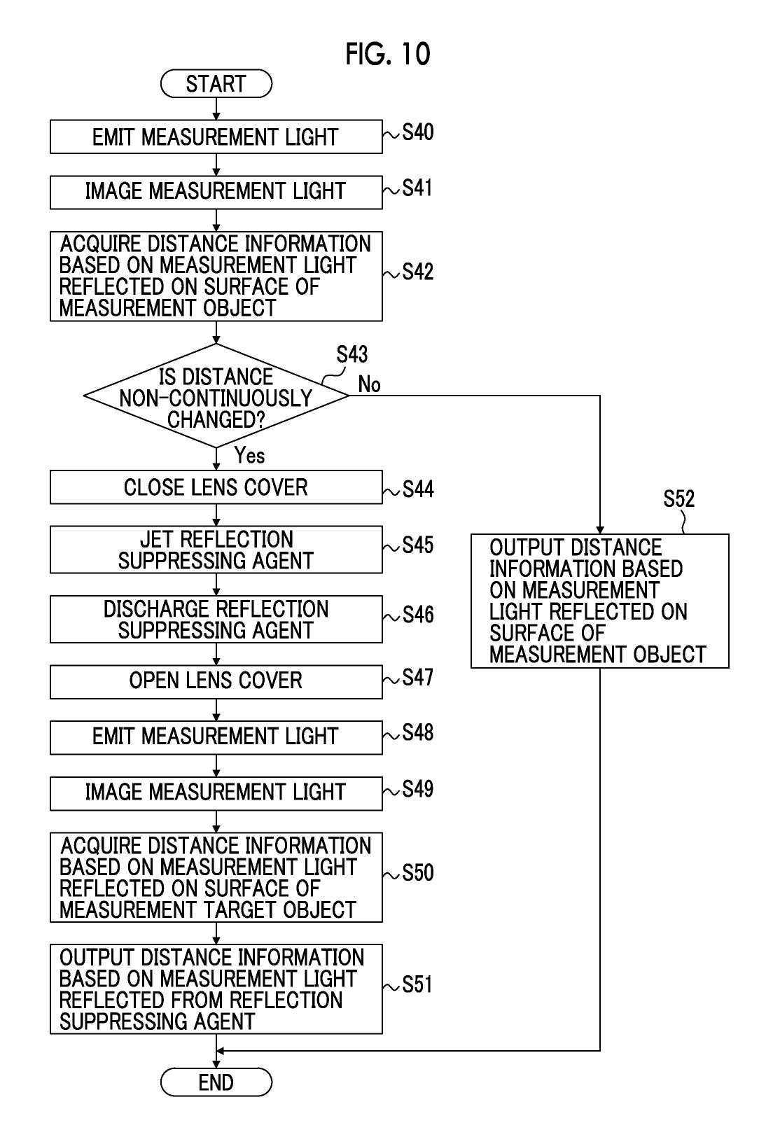

FIG. 10 is a flowchart of the distance information acquisition apparatus 10 according to this embodiment.

First, measurement light P is emitted to a measurement object by the pulse light emitting section 22 (step S40). In this case, jetting of a reflection suppressing agent is not performed with respect to the measurement object, and the measurement light P is reflected on a surface of the measurement object. Further, in this case, the lens cover 42 is opened, and the imaging lens 12 is not affected by the influence of the lens cover 42, so that the measurement light P can be imaged. Then, the measurement light P reflected on the surface of the measurement object is imaged on an image sensor through the imaging lens 12 (step S41). Further, the distance information acquisition section 21 acquires distance information based on the measurement light P reflected on the surface of the measurement object (step S42). Then, the multiple reflection determination section 25 determines whether the measurement light P is multiply reflected on the basis of the acquired distance information (step S43). For example, in a case where distance information continuously changes from a short distance to a long distance, the multiple reflection determination section 25 determines that the measurement light P is not multiply reflected (No in step S43). In this case, the distance information acquisition apparatus 10 outputs the acquired distance information as a measurement result by the CPU 20 (step S52).

On the other hand, in a case where the distance information non-continuously changes from the short distance to the long distance, the multiple reflection determination section 25 determines that the measurement light P is multiply reflected (Yes in step S43). In a case where the multiple reflection determination section 25 determines that the measurement light P is multiply reflected, the CPU 20 outputs a command for closing the lens cover 42 to the cover operating mechanism 40, and then, the lens cover 42 is closed (step S44). Then, a command for jetting of a reflection suppressing agent is output from the CPU 20, and the reflection suppressing agent is jetted onto the measurement object by the jet 26 (step S45). After the jetting of the reflection suppressing agent is terminated, the reflection suppressing agent is discharged from a measurement space by the discharger 28 (step S46). After the discharge of the reflection suppressing agent is terminated, the CPU 20 outputs a command for opening the lens cover 42 to the cover operating mechanism 40, and then, the cover operating mechanism 40 opens the lens cover 42 (step S47).

After the lens cover 42 is opened, light emission of the measurement light P is performed using the pulse light emitting section 22 (step S48). The measurement light P emitted by the pulse light emitting section 22 is reflected from the reflection suppressing agent of the surface of the measurement object since the reflection suppressing agent is attached to the surface of the measurement object. That is, multiple reflection of the measurement light P reflected from the reflection suppressing agent of the surface of the measurement object is suppressed. Then, the measurement light P reflected from the reflection suppressing agent is imaged in the distance image sensor 14 through the imaging lens 12 (step S49). Then, the distance information acquisition section 21 acquires distance information based on the measurement light P reflected from the reflection suppressing agent (step S50). Further, the distance information acquisition apparatus 10 outputs the distance information based on the measurement light P reflected from the reflection suppressing agent by the CPU 20 (step S51).

Further, an example in which attachment prevention sections (the lens cover 42 and the cover operating mechanism 40) of the imaging lens 12 are provided in the distance information acquisition apparatus 10 that includes the discharger 28 is shown in FIG. 10, but the attachment prevention sections of the imaging lens 12 may be provided in the distance information acquisition apparatus 10 that does not include the discharger 28. In this case, the lens cover 42 covers the imaging lens 12 from a time before the jet 26 jets the reflection suppressing agent to a time after the discharger 28 finishes discharging the reflection suppressing agent.

Next, a modification example of the third embodiment will be described.

In this example, an attachment prevention section (first attachment prevention section) of the imaging lens 12 for preventing a reflection suppressing agent from being attached to the imaging lens 12 is formed by a wiper.

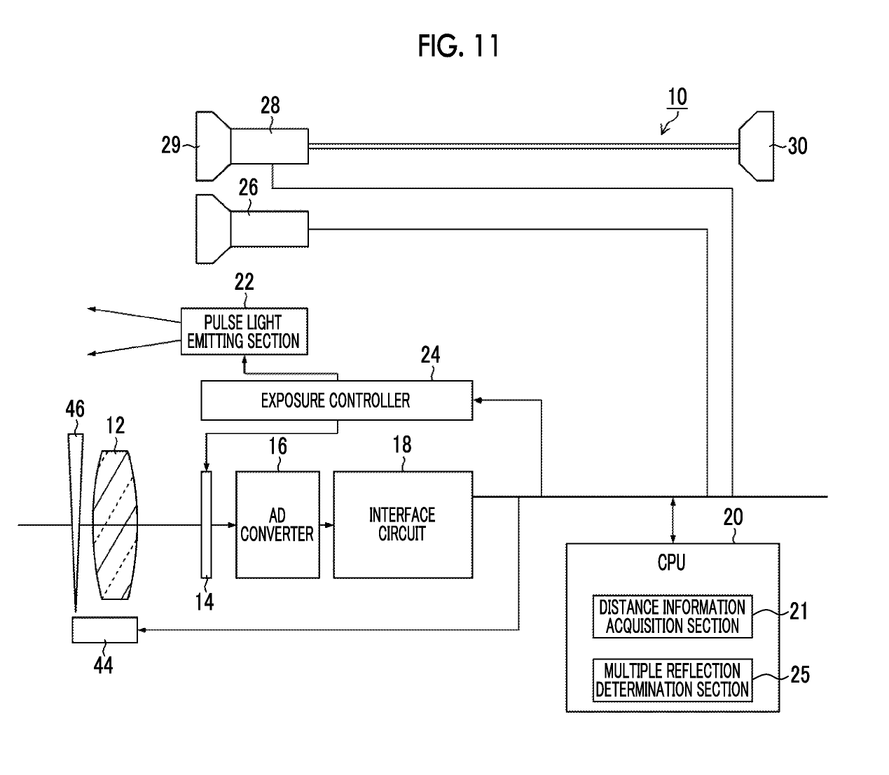

FIG. 11 is a block diagram showing a functional configuration example of the distance information acquisition apparatus 10 according to this modification example. The same reference numerals are given to the same portions described in FIGS. 1 and 6, and description thereof will not be repeated.

The distance information acquisition apparatus 10 shown in FIG. 11 includes a wiper 46 for preventing attachment to the imaging lens 12, and the wiper 46 is operated by a wiper operating mechanism 44. The wiper 46 has a function for removing a reflection suppressing agent attached to the imaging lens 12.

### Fourth Embodiment

Next, a fourth embodiment of the invention will be described. In this embodiment, an attachment prevention section (second attachment prevention section) of the pulse light emitting section 22 that prevents a reflection suppressing agent from being attached to a measurement light source is provided.

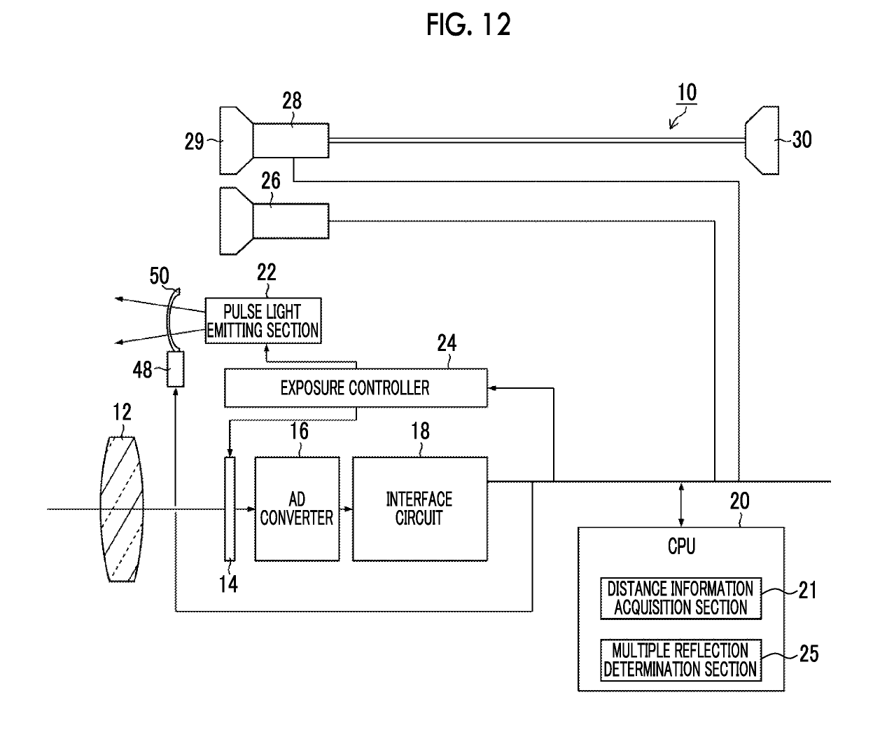

FIG. 12 is a block diagram showing a functional configuration example of the distance information acquisition apparatus 10 according to this embodiment. The same reference numerals are given to the same portions described in FIGS. 1 and 6, and description thereof will not be repeated.

The distance information acquisition apparatus 10 shown in FIG. 12 includes a light emitting section cover 50 for preventing attachment to the pulse light emitting section 22, and the light emitting section cover 50 is opened or closed by the cover operating mechanism 48. The light emitting section cover 50 is a cover that covers the pulse light emitting section 22, and prevents a reflection suppressing agent from being attached to the pulse light emitting section 22.

For example, the light emitting section cover 50 covers the pulse light emitting section 22 from a time before the jet 26 jets the reflection suppressing agent to a time after the discharger 28 finishes discharging the reflection suppressing agent. Thus, it is possible to prevent the reflection suppressing agent from being attached to the pulse light emitting section 22, and to suppress the influence of the light emitting section cover 50 on light emission of measurement light P from the pulse light emitting section 22.

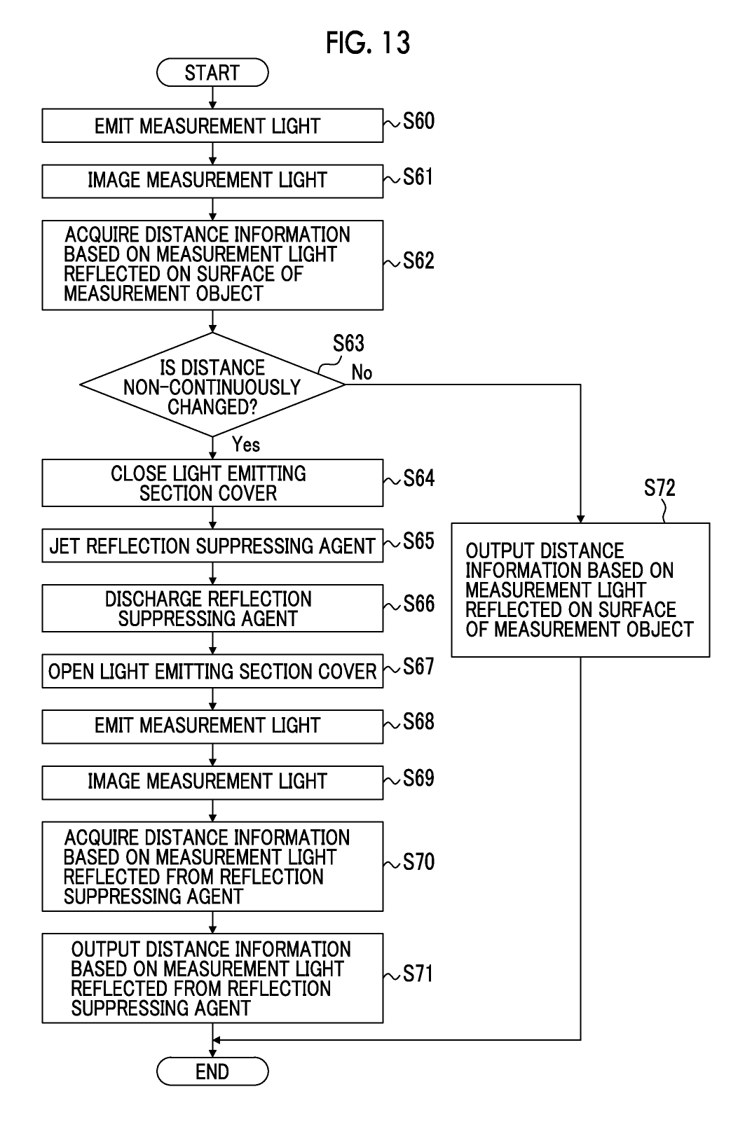

FIG. 13 is a flowchart showing an operation of the distance information acquisition apparatus 10 according to this embodiment.

First, measurement light P is emitted to a measurement object by the pulse light emitting section 22 (step S60). In this case, jetting of a reflection suppressing agent is not performed with respect to the measurement object, and the measurement light P is reflected on a surface of the measurement object. Further, in this case, the lens cover 42 is opened, so that the imaging lens 12 can accurately image the measurement light P. Then, the measurement light P reflected on the surface of the measurement object is imaged on an image sensor through the imaging lens 12 (step S61). Further, the distance information acquisition section 21 acquires distance information based on the measurement light P reflected on the surface of the measurement object (step S62). Then, the multiple reflection determination section 25 determines whether the measurement light P is multiply reflected on the basis of the acquired distance information (step S63). For example, in a case where distance information continuously changes from a short distance to a long distance, the multiple reflection determination section 25 determines that the measurement light P is not multiply reflected (No in step S63). In this case, the distance information acquisition apparatus 10 outputs the distance information based on the measurement light reflected on the surface of the measurement object by the CPU 20 (step S72).

On the other hand, in a case where the distance information non-continuously changes from the short distance to the long distance, the multiple reflection determination section 25 determines that the measurement light P is multiply reflected (Yes in step S63). In a case where the multiple reflection determination section 25 determines that the measurement light P is multiply reflected, the CPU 20 outputs a command for closing the light emitting section cover 50 to the cover operating mechanism 48, and then, the light emitting section cover 50 is closed (step S64). Then, a command for jetting of a reflection suppressing agent is output from the CPU 20, and then, the reflection suppressing agent is jetted onto the measurement object by the jet 26 (step S65). After the jetting of the reflection suppressing agent is terminated, the reflection suppressing agent is discharged from a measurement space by the discharger 28 (step S66). After the discharge of the reflection suppressing agent is terminated, the CPU 20 outputs a command for opening the light emitting section cover 50 to the cover operating mechanism 48, and then, the cover operating mechanism 48 opens the light emitting section cover 50 (step S67).

After the light emitting section cover 50 is opened, light emission of measurement light P is performed by the pulse light emitting section 22 (step S68). The measurement light P emitted by the pulse light emitting section 22 is reflected from the reflection suppressing agent of the surface of the measurement object since the reflection suppressing agent is attached to the surface of the measurement object. That is, multiple reflection of the measurement light P reflected from the reflection suppressing agent of the surface of the measurement object is suppressed. Then, the measurement light P reflected from the reflection suppressing agent is imaged in the distance image sensor 14 through the imaging lens 12 (step S69). Then, the distance information acquisition section 21 acquires distance information based on the measurement light P reflected from the reflection suppressing agent (step S70). Further, the distance information acquisition apparatus 10 outputs the distance information based on the measurement light P reflected from the reflection suppressing agent by the CPU 20 (step S71).

Further, an example in which attachment prevention sections (the light emitting section cover 50 and the cover operating mechanism 48) of the pulse light emitting section 22 are provided in the distance information acquisition apparatus 10 that includes the discharger 28 is shown in FIG. 13, but the attachment prevention sections of the imaging lens 12 may be provided in the distance information acquisition apparatus 10 that does not include the discharger 28. In this case, the light emitting section cover 50 covers the pulse light emitting section 22 from a time before the jet 26 jets the reflection suppressing agent to a time after the discharger 28 finishes discharging, the reflection suppressing agent.

Next, a modification example of the fourth embodiment will be described.

In this example, an attachment prevention section (second attachment prevention section) of the imaging lens 12 for preventing a reflection suppressing agent from being attached to the imaging lens 12 is formed by a wiper.

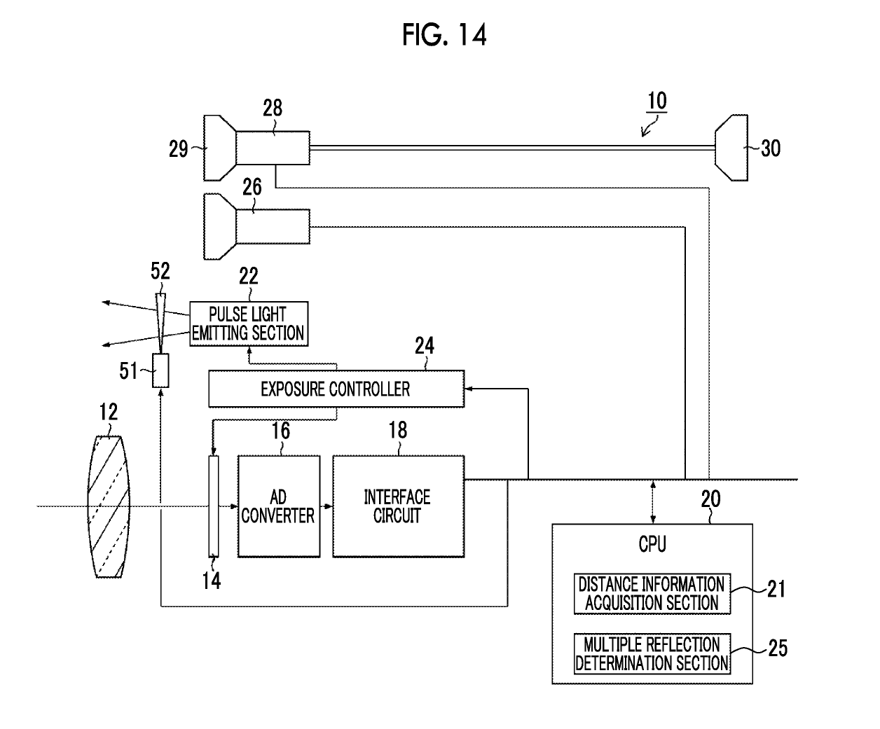

FIG. 14 is a block diagram showing a functional configuration example of the distance information acquisition apparatus 10 according to this modification example. The same reference numerals are given to the same portions described in FIGS. 1 and 6, and description thereof will not be repeated.

The distance information acquisition apparatus 10 shown in FIG. 14 includes a wiper 52 for preventing attachment to the pulse light emitting section 22, and the wiper 52 is operated by a wiper operating mechanism 51. The wiper 52 has a function for removing a reflection suppressing agent attached to the pulse light emitting section 22.

Hereinbefore, the embodiments of the invention have been described, but the invention is not limited to the above-described embodiments, and various modifications may also be made in a range without departing from the concept of the invention.

### EXPLANATION OF REFERENCES

10: distance information acquisition apparatus

12: imaging lens

14: distance image sensor

16: AD converter

18: interface circuit

20: CPU

21: distance information acquisition section

22: pulse light emitting section

24: exposure controller

25: multiple reflection determination section

26: jet

28: discharger

29: suction port

30: discharge port

40, 48: cover operating mechanism

42: lens cover

44, 51: wiper operating mechanism

46, 52: wiper

50: light emitting section cover

step S10 to step S13: distance information acquisition process of first embodiment

step S20 to step S30: distance information acquisition process of second embodiment

step S40 to step S52: distance information acquisition process of third embodiment

step S60 to step S72: distance information acquisition process of fourth embodiment

What is claimed is:

1. A distance information acquisition apparatus comprising:
a measurement light source that emits measurement light to a measurement object;
a distance image sensor in which a plurality of light receiving elements are two-dimensionally arranged;
a jetting section that jets a reflection suppressing agent to the measurement object;
an imaging lens that images the measurement light reflected on a surface of the measurement object to which the reflection suppressing agent jetted from the jetting section is attached on the distance image sensor;
a distance information acquisition section that acquires distance information of the surface of the measurement object, which is first distance information corresponding to a time of flight of the measurement light reflected from the reflection suppressing agent on the surface of the measurement object, on the basis of an output signal of each light receiving element of the distance image sensor; and
a discharge section that discharges the reflection suppressing agent that is not attached to the surface of the measurement object in the reflection suppressing agent jetted by the jetting section,
wherein the distance information acquisition section acquires the distance information after the discharge in the discharge section is terminated.

2. The distance information acquisition apparatus according to claim 1,
wherein the distance information acquisition section acquires second distance information corresponding to a time of flight of the measurement light reflected from the surface of the measurement object to which the reflection suppressing agent is not attached,
wherein the distance information acquisition apparatus further comprises a multiple reflection determination section that determines that the measurement light is multiply reflected on the basis of the second distance information, and
wherein in a case where the multiple reflection determination section determines that the measurement light is multiply reflected, the jetting section jets the reflection suppressing, agent, and in a case where the multiple reflection determination section determines that the measurement light is not multiply reflected, the jetting section does not jet the reflection suppressing agent.

3. The distance information acquisition apparatus according to claim 2,
wherein in a case where the second distance information continuously changes from a short distance to a long distance, the multiple reflection determination section determines that the measurement light is not multiply reflected, and in a case where the second distance information non-continuously changes from the short distance to the long distance, the multiple reflection determination section determines that the measurement light is multiply reflected.

4. The distance information acquisition apparatus according to claim 2,
wherein in a case where the second distance information repeats binary values in a region, the multiple reflection determination section determines that the measurement light is multiply reflected, and in a case where the second distance information does not repeat the binary values in the region, the multiple reflection determination section determines that the measurement light is not multiply reflected.

5. The distance information acquisition apparatus according to claim 1,
wherein the reflection suppressing agent reflects the measurement light with a uniform reflectivity.

6. The distance information acquisition apparatus according to claim 5,
wherein the reflection suppressing agent includes fine particles.

7. The distance information acquisition apparatus according to claim 6,
wherein the diameters of the fine particles are 1/10 or greater and 10 times or smaller of a wavelength of the measurement light.

8. The distance information acquisition apparatus according to claim 1,
wherein the discharge section discharges the reflection suppressing agent by performing suction or extrusion.

9. The distance information acquisition apparatus according to claim 1, further comprising:
a first attachment prevention section that prevents the reflection suppressing agent from being attached to the imaging lens.

10. The distance information acquisition apparatus according to claim 9,
wherein the first attachment prevention section is formed by a wiper.

11. The distance information acquisition apparatus according to claim 9,
wherein the first attachment prevention section is formed by a cover that covers the imaging lens.

12. The distance information acquisition apparatus according to claim 11,
wherein the cover covers the imaging lens from a time before the jetting section jets the reflection suppressing agent to a time after the discharge section finishes discharging the reflection suppressing agent.

13. The distance information acquisition apparatus according to claim 1, further comprising:
a first attachment prevention section that prevents the reflection suppressing agent from being attached to the imaging lens,
wherein the first attachment prevention section is a cover, and
wherein the cover covers the imaging lens while the jetting section is jetting the reflection suppressing agent.

14. The distance information acquisition apparatus according to claim 1, further comprising:
a second attachment prevention section that prevents the reflection suppressing agent from being attached to the measurement light source.

15. The distance information acquisition apparatus according to claim 14,
wherein the second attachment prevention section is a wiper.

16. The distance information acquisition apparatus according to claim 14,
wherein the second attachment prevention section is a cover that covers the measurement light source.

17. The distance information acquisition apparatus according to claim 16,
wherein the cover covers the measurement light source from a time before the jetting section jets the reflection suppressing agent to a time after the discharge section finishes discharging the reflection suppressing agent.

18. The distance information acquisition apparatus according to claim 1, further comprising:
a second attachment prevention section that prevents the reflection suppressing agent from being attached to the measurement light source,
wherein the second attachment prevention section is a cover, and
wherein the cover covers the measurement light source while the jetting section is jetting the reflection suppressing agent.

19. A distance information acquisition method comprising:
a step of emitting measurement light to a measurement object;
a step of jetting a reflection suppressing agent to the measurement object;
a step of imaging the measurement light reflected on a surface of the measurement object to which the reflection suppressing agent jetted in the jetting step is attached on a distance image sensor in which a plurality of light receiving elements are two-dimensionally arranged, using an imaging lens;
a step of acquiring distance information of the surface of the measurement object, which is first distance information corresponding to a time of flight of the measurement light reflected from the reflection suppressing agent on the surface of the measurement object, on the basis of an output signal of each light receiving element of the distance image sensor; and
a step of discharging the reflection suppressing agent that is not attached to the surface of the measurement object in the reflection suppressing agent jetted by the jetting section,
wherein the step of acquiring the distance information acquires the distance information, after the discharge in the discharge section is terminated.
